(19) United States
(12) Patent Application Publication
(10) Pub. No.: US 2026/0137588 A1
(43) Pub. Date: May 21, 2026

(54) INTERCHANGEABLE MASSAGER ATTACHMENT FOR ELECTRIC TOOTHBRUSH

(71) Applicant: Izi Nae, Los Angeles, CA (US)

(72) Inventor: Izi Nae, Los Angeles, CA (US)

(21) Appl. No.: 19/280,793

(22) Filed: Jul. 25, 2025

Related U.S. Application Data
(60) Provisional application No. 63/722,667, filed on Nov. 20, 2024.

(51) Int. Cl. A61H 23/02; A61C 17/22

(52) U.S. Cl. CPC A61H 23/0254; A61C 17/225; A61H 2201/0107; A61H 2201/0157; A61H 2201/1215; A61H 2201/1685; A61H 2201/1692

(57) ABSTRACT

An interchangeable personal massager attachment device for electric toothbrushes may include an attachment body having a first end and a second end, the first end of the attachment body being configured to be removably engaged with an electric toothbrush handle; and at least one massager head operatively attached to the second end of the attachment body, wherein the at least one massager head is a non-toothbrush head attachment, and, when the attachment body is engaged with the electric toothbrush handle, powering on the electric toothbrush handle drives vibration or movement of the at least one massager head.

### RELATED APPLICATION

This application claims priority to provisional patent application U.S. Ser. No. 63/722,667 filed on Nov. 20, 2024, the entire contents of which is herein incorporated by reference.

### BACKGROUND

The embodiments described herein relate generally to personal care and, more particularly, to a discreet, interchangeable massager attachment for an electric toothbrush, wherein the massager attachment is configured to removably engage with a plurality of various, interchangeable massager heads.

Existing personal massagers are often bulky, conspicuous, require separate power sources, and are not designed with discretion or portability in mind. In fact, there is a lack of discreet, versatile, and easily interchangeable massager attachments for electric toothbrushes, limiting personal wellness and pleasure options for users who prefer multifunctional devices. More specifically, many people lack a discreet, hygienic, and travel friendly solution for personal massage or sensitive area stimulation using a familiar and compact device.

Therefore, what is needed is an interchangeable attachment configured to engage with an electric toothbrush handle, wherein the interchangeable attachment is configured to engage with a plurality of interchangeable massager heads to provide a discreet, personal massager.

### SUMMARY

Some embodiments of the present disclosure include an interchangeable personal massager attachment device for electric toothbrushes. The interchangeable personal massager attachment device may include an attachment body having a first end and a second end, the first end of the attachment body being configured to be removably engaged with an electric toothbrush handle; and at least one massager head operatively attached to the second end of the attachment body, wherein the at least one massager head is a non-toothbrush head attachment, and, when the attachment body is engaged with the electric toothbrush handle, powering on the electric toothbrush handle drives vibration or movement of the at least one massager head.

### BRIEF DESCRIPTION OF THE FIGURES

The detailed description of some embodiments of the invention is made below with reference to the accompanying figures, wherein like numerals represent corresponding parts of the figures.

FIG. 1 is a perspective view of one embodiment of the present disclosure.

FIG. 2 is a front perspective exploded view of one embodiment of the present disclosure.

FIG. 3 is a rear perspective exploded view of one embodiment of the present disclosure.

FIG. 4 is a top view of one embodiment of the present disclosure.

FIG. 5 is a section view of one embodiment of the present disclosure, taken along line 5-5 in FIG. 4.

FIG. 6 is a front view of exemplary alternate massage heads.

### DETAILED DESCRIPTION

In the following detailed description of the invention, numerous details, examples, and embodiments of the invention are described. However, it will be clear and apparent to one skilled in the art that the invention is not limited to the embodiments set forth and that the invention can be adapted for any of several applications.

The device of the present disclosure may be used as a discreet personal massager and may comprise the following elements. This list of possible constituent elements is intended to be exemplary only, and it is not intended that this list be used to limit the device of the present application to just these elements. Persons having ordinary skill in the art relevant to the present disclosure may understand there to be equivalent elements that may be substituted within the present disclosure without changing the essential function or operation of the device.

The various elements of the present disclosure may be related in the following exemplary fashion. It is not intended to limit the scope or nature of the relationships between the various elements, and the following examples are presented as illustrative examples only.

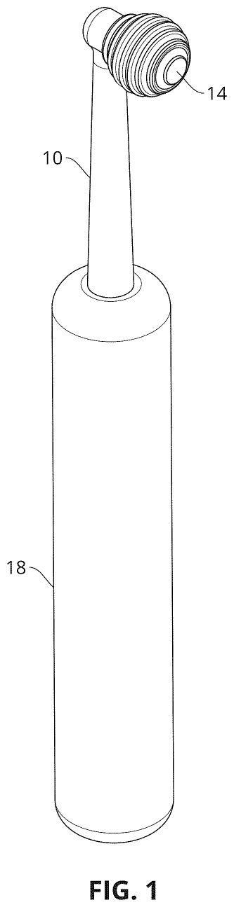

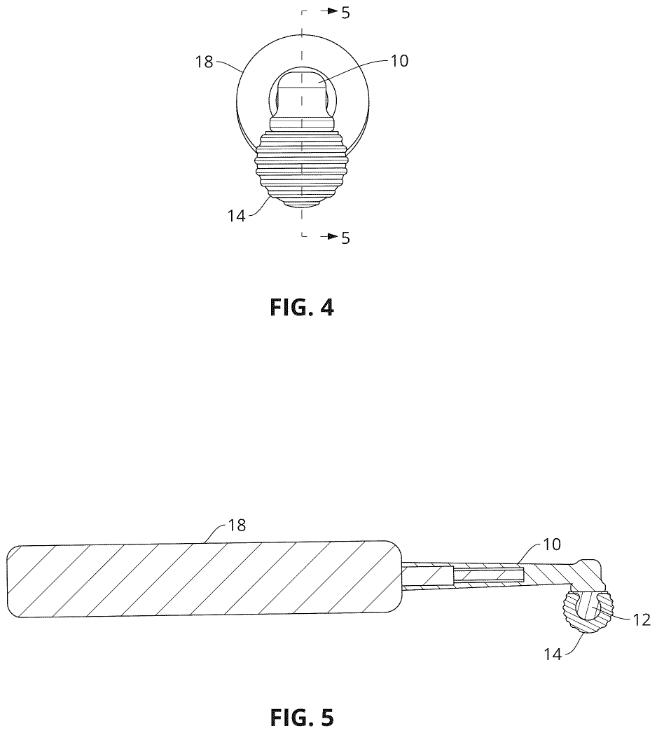

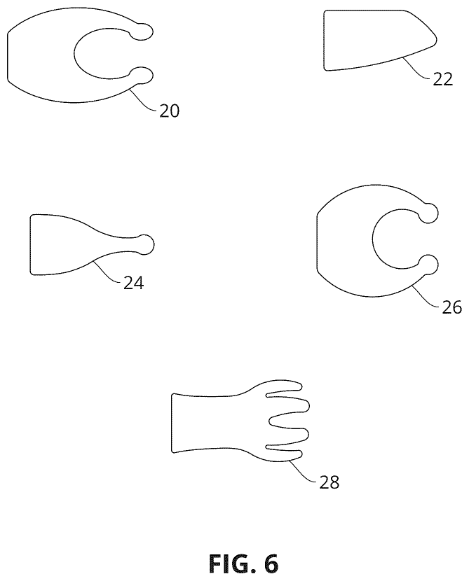

By way of example, and referring to FIGS. 1-6, some embodiments of the present disclosure include an interchangeable personal massager attachment device for electric toothbrushes, the interchangeable personal massager attachment device comprising an attachment body 10 having a first end and a second end, the first end of the attachment body 10 being configured to removably engage with an existing electric toothbrush handle 18; and at least one massager head operatively attached to the second end of the attachment body 10, wherein the at least one massager head is a non-toothbrush head attachment and when the attachment body 10 is engaged with the electric toothbrush handle 18, powering on the electric toothbrush handle 18 drives vibration or movement of the at least one massager head.

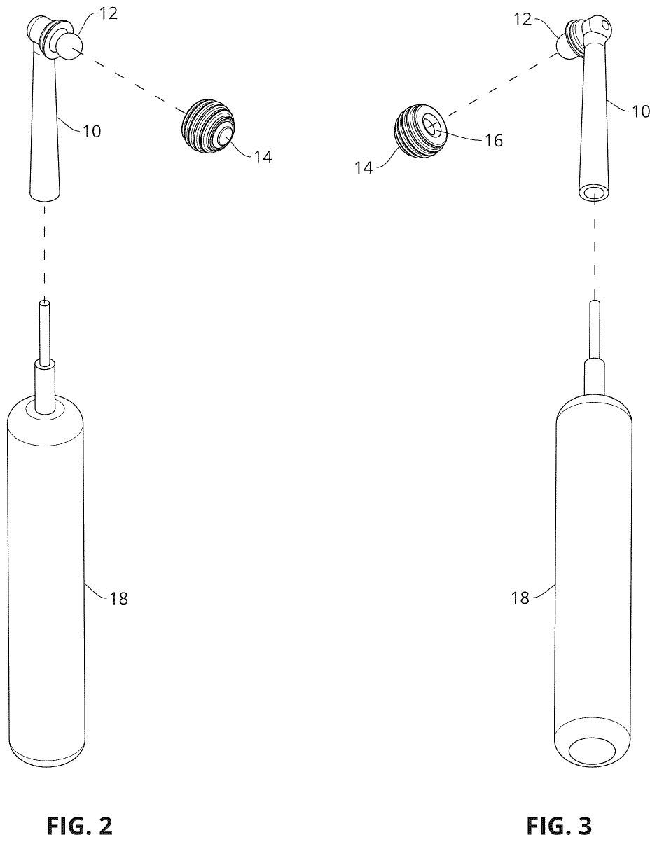

More specifically, and as shown in the Figures, the attachment body 10 may be similar in structure to a conventional electric toothbrush interchangeable brush attachment. However, as shown in FIGS. 2-5, for example, the second end of the attachment body 10 may include a connection structure, such as a ball post 12. The at least one massager head may comprise a massager head body with a socket 16 extending therein, the socket 16 sized to accommodate insertion of the ball post 12 therein. As shown in the Figures, the at least one massager head may comprise a variety of massager protrusions, bumps, textures, and the like extending therefrom. In some embodiments, the device may comprise a plurality of interchangeable massager heads configured to removably and interchangeably engage with the ball post 12. In embodiments, each of the massager heads may be made of a material suitable for massaging and stimulation, such as silicone. Exemplary massager heads include a ribbed ball head 14, as shown in FIGS. 1-5, and other variously shaped massager heads, such as those shown in FIG. 6. For example, the massager heads may include an elongate, C-shaped massage head 20, a wedge shaped massage head 22, a tapered massage head 24 with a bulbous end, a wider C-shaped massage head 26, and a multi-pronged concave ended massage head 28.

In other embodiments, the present disclosure comprises a system for providing a discreet personal massaging device, the system comprising an electric toothbrush handle 18, an attachment body 10 having a first end and a second end, the first end of the attachment body 10 being configured to be removably engaged with the electric toothbrush handle 18; and at least one massager head operatively attached to the second end of the attachment body 10, wherein, when the attachment body 10 is engaged with the electric toothbrush handle 18, powering on the electric toothbrush handle 18 drives vibration or movement of the at least one massager head. The system may further comprise a detachable toothbrush head configured to removably engage with the electric toothbrush handle 18, thus providing the appearance that a user is simply carrying a conventional electric toothbrush.

While the device of the present disclosure is described as being primarily intended for personal wellness and massage, it could be adapted for other uses, such as cosmetic application (i.e., makeup brush or skincare exfoliator heads), pet grooming attachments, or dental care tools. The modular nature of the adapter and head system allows for versatility across multiple industries where controlled oscillation or vibration is beneficial.

To use the attachment device of the present disclosure, a user may attach the attachment body 10 to any conventional electric toothbrush handle 18 in the manner in which a conventional toothbrush head is attached thereto. The desired massager head may then be placed onto the second end of the attachment body 10. The electric toothbrush handle 18 may then be powered on in a conventional manner, causing the attachment body 10 and, thus, the massager head to vibrate. The vibrating device may then be used as a personal massager for any variety of massaging or therapeutic purposes.

The above-described embodiments of the invention are presented for purposes of illustration and not of limitation. While these embodiments of the invention have been described with reference to numerous specific details, one of ordinary skill in the art will recognize that the invention can be embodied in other specific forms without departing from the spirit of the invention. Thus, one of ordinary skill in the art would understand that the invention is not to be limited by the foregoing illustrative details, but rather is to be defined by the appended claims.

What is claimed is:

1. An interchangeable personal massager attachment device for electric toothbrushes, the interchangeable personal massager attachment device comprising:
an attachment body having a first end and a second end, the first end of the attachment body being configured to be removably engaged with an electric toothbrush handle; and
at least one massager head operatively attached to the second end of the attachment body,
wherein:
the at least one massager head is a non-toothbrush head attachment; and
when the attachment body is engaged with the electric toothbrush handle, powering on the electric toothbrush handle drives vibration or movement of the at least one massager head.

2. The interchangeable personal massager attachment device of claim 1, wherein:
the second end of the attachment body includes a connection structure; and
the at least one massager head has a complimentary connection structure configured to removably engage with the connection structure on the second end.

3. The interchangeable personal massager attachment device of claim 2, wherein:
the connection structure is a ball post; and
the complimentary connection structure is a socket size to accommodate insertion of the ball post therein.

4. The interchangeable personal massager attachment device of claim 1, wherein the at least one massager head comprises has an outer surface comprising at least one member selected from the group consisting of massager protrusions, bumps, textures, and ribs.

5. The interchangeable personal massager attachment device of claim 1, wherein the at least one massager head comprises silicone.

6. A system for providing a discreet personal massaging device, the system comprising:
an electric toothbrush handle;
an attachment body having a first end and a second end, the first end of the attachment body being configured to be removably engaged with the electric toothbrush handle; and
at least one massager head operatively attached to the second end of the attachment body,
wherein:
the at least one massager head is a non-toothbrush head attachment; and
when the attachment body is engaged with the electric toothbrush handle, powering on the electric toothbrush handle drives vibration or movement of the at least one massager head.

7. The system of claim 6, further comprising a detachable toothbrush head configured to removably engage with the electric toothbrush handle.

8. The system of claim 6, wherein:
the second end of the attachment body includes a connection structure; and
the at least one massager head has a complimentary connection structure configured to removably engage with the connection structure on the second end.

9. The system of claim 8, wherein:
the connection structure is a ball post; and
the complimentary connection structure is a socket size to accommodate insertion of the ball post therein.

10. The system of claim 6, wherein the at least one massager head comprises has an outer surface comprising at least one member selected from the group consisting of massager protrusions, bumps, textures, and ribs.
